(19) United States
(12) Patent Application Publication
(10) Pub. No.: US 2026/0274463 A1
(43) Pub. Date: Sep. 17, 2026

(54) ROTATIONAL SUPPORT DEVICE FOR FLYING OBJECT AND MANUFACTURING METHOD THEREOF

(71) Applicant: NSK LTD., Tokyo (JP)

(72) Inventors: Nagao DOHI, Fujisawa-shi (JP); Masafumi HIKIDA, Fujisawa-shi (JP)

(73) Assignee: NSK LTD., Tokyo (JP)

(21) Appl. No.: 19/473,633

(22) PCT Filed: Feb. 7, 2024
(86) PCT No.: PCT/JP2024/004144

§ 371 Date: Oct. 8, 2025

(30) Foreign Application Priority Data
Apr. 28, 2023 (JP) 2023-074081

(51) Int. Cl. B64U 30/29; F16C 19/54

(52) U.S. Cl. CPC B64U 30/29; F16C 19/542; F16C 2326/43

(57) ABSTRACT

The rotational support device for flying object has a stationary body having double-row outer ring raceways, each of which is of an angular type, on an inner circumferential surface thereof, a rotating body having double-row inner ring raceways, each of which is of an angular type, on an outer circumferential surface thereof, and capable of supporting a propeller of a flying object on a first side in an axial direction, and balls arranged between the double-row outer ring raceways and the double-row inner ring raceways in a state where a back-to-back contact angle is applied to each row of the balls. A pitch circle diameter of first balls of the balls arranged on the first side in the axial direction and a pitch circle diameter of second balls of the balls arranged on a second side in the axial direction are different from each other.

### TECHNICAL FIELD

The present disclosure relates to a rotational support device for flying object for supporting a propeller and a drive motor of a flying object, and to a manufacturing method of the rotational support device for flying object.

### BACKGROUND ART

A flying object such as a drone includes an airframe, a propeller for obtaining upward lift, and a rotational drive device for flying object that rotatably supports the propeller with respect to the airframe and rotationally drives the propeller.

The rotational drive device for flying object includes a rotational support device for flying object and a drive motor.

A conventionally known rotational support device for flying object includes a stationary side support member, a rotating side support member, and a support bearing. The stationary side support member is supported and fixed to the airframe. The rotating side support member supports the propeller and rotates integrally with the propeller. Therefore, the rotating side support member is supported so as to be able to rotate freely around its central axis of rotation relative to the stationary side support member by using the support bearing.

The drive motor includes a motor stator and a motor rotor. The motor stator is supported and fixed to the stationary side support member. The motor rotor is supported and fixed to the rotating side support member so as to face the motor stator. From the aspect of increasing an output of the drive motor, it is preferable to minimize a gap between the motor stator and the motor rotor as much as possible.

The propeller is supported and fixed to the rotational support member so that its central axis of rotation coincides with the central axis of rotation of the rotational support member.

The rotational drive device for flying object rotationally drives the rotational support member and the propeller supported and fixed to the rotational support member by energizing the motor stator to generate an electromagnetic force for rotating the motor rotor with respect to the motor stator.

As a more specific conventional structure of a rotational support device for flying object, JP 2020-072530 (A) discloses a structure using a pair of deep groove ball bearings as a support bearing, each of which includes an outer ring fitted into a stationary side support member, an inner ring externally fitted to the rotating side support member, and a plurality of balls. In this structure, between the pair of deep groove ball bearings, the balls have the same pitch circle diameter. Further, the pair of deep groove ball bearings are arranged separated from each other in the axial direction.

Further, J P 2020-045087 (A) discloses a structure in which a pair of angular ball bearings are used instead of a pair of deep groove ball bearings as a support bearing. In this structure, between the pair of angular ball bearings, the balls have the same pitch circle diameter. The pair of angular ball bearings are arranged without being separated in the axial direction, that is, arranged adjacent to each other in the axial direction. Further, a back-to-back (DB type) contact angle and preload are applied to the plurality of balls of each of the angular ball bearings.

### CITATION LIST

### Patent Literature

Patent Literature 1: JP 2020-072530 (A)
Patent Literature 2: JP 2020-045087 (A)

### SUMMARY OF INVENTION

### Technical Problem

In the conventional structure described in JP 2020-072530 (A), since preload is not applied to each deep groove ball bearing, the stationary side support member and the rotating side support member can be relatively displaced in the axial direction by the amount of axial internal gap of each deep groove ball bearing. Therefore, when transporting a flying object by loading it on a vehicle bed or the like, the rotating side support member vibrates in the axial direction relative to the stationary side support member, and as a result, the motor rotor and propeller supported by the rotating side support member may be easily damaged.

In contrast, in the conventional structure described in JP 2020-045087 (A), since a back-to-back (DB type) contact angle and preload are applied to each angular ball bearing, the stationary side support member and the rotating side support member can be prevented from relatively displacing in the axial direction. Therefore, when transporting a flying object by loading it on a vehicle bed or the like, the rotating side support member is prevented from vibrating in the axial direction relative to the stationary side support member so that, and there is an advantage that it is easy to protect the motor rotor and propeller supported by the rotating side support member.

However, the conventional structure described in JP 2020-045087 (A) has room for improvement in terms of downsizing the rotational support device for flying object, while ensuring bearing performance such as rotational efficiency (low heat generation) and L10 life equal to or better than those of a pair of deep groove ball bearings.

An object of the present disclosure is to provide a rotational support device for flying object and a manufacturing method thereof that can efficiently achieve downsizing while ensuring bearing performance.

### Solution to Problem

A rotational support device for flying object of an aspect of the present disclosure includes a stationary body, a rotating body, and a plurality of balls.

The stationary body has double-row outer ring raceways, each of which is of an angular type, on an inner circumferential surface thereof.

The rotating body has double-row inner ring raceways, each of which is of an angular type, on an outer circumferential surface thereof, and is capable of supporting a propeller of a flying object on a first side in the axial direction.

The balls are arranged between the double-row outer ring raceways and the double-row inner ring raceways, in a state where a back-to-back contact angle is applied to each row of balls. The contact angle is not particularly limited, but preferably it is 30° or more and 45° or less.

Of the balls, a pitch circle diameter PCD1 of first balls arranged on a first side in the axial direction and a pitch circle diameter PCD2 of second balls arranged on a second side in the axial direction are different from each other.

In the rotational support device for flying object of an aspect of the present disclosure, the stationary body has a stationary side support member, a first outer ring having a first outer ring raceway arranged on the first side in the axial direction on an inner circumferential surface thereof and internally fitted to the stationary side support member, and a second outer ring having a second outer ring raceway arranged on the second side in the axial direction on an inner circumferential surface thereof and internally fitted to the stationary side support member. The rotating body has a rotating side support member, a first inner ring having a first inner ring raceway arranged on the first side in the axial direction on an outer circumferential surface thereof and externally fitted to the rotating side support member, and a second inner ring having a second inner ring raceway arranged on the second side in the axial direction on an outer circumferential surface thereof and externally fitted to the rotating side support member.

In the rotational support device for flying object of an aspect of the present disclosure, the first outer ring and the second outer ring are arranged separated from each other in the axial direction, and the first inner ring and the second inner ring are arranged separated from each other in the axial direction.

In a rotational support device for flying object of an aspect of the present disclosure, the stationary body includes a stationary side support member in which the first outer ring raceway arranged on the first side in the axial direction on an inner circumferential surface thereof and a second outer ring raceway arranged on the second side in the axial direction are directly formed on the inner circumferential surface thereof.

In the rotational support device for flying object of an aspect of the present disclosure, the rotating body includes a rotating side support member in which a first inner ring raceway arranged on the first side in the axial direction is directly formed on an outer circumferential surface thereof, and an inner ring having a second inner ring raceway arranged on the second side in the axial direction on an outer circumferential surface thereof and externally fitted to the rotating side support member.

The rotational support device for flying object of the present disclosure can be implemented by appropriately combining the respective aspects described above within a range that does not cause contradictions.

A method for manufacturing the rotational support device for flying object of an aspect of the present disclosure includes a step of determining a size relationship between the pitch circle diameter of the first balls and the pitch circle diameter of the second balls in accordance with load conditions acting on the rotating body during use of a flying object to which the rotational support device for flying object is applied.

### Effect of Invention

With the present disclosure, it is possible to provide a rotational support device for flying object and a manufacturing method thereof that can efficiently achieve downsizing while ensuring bearing performance.

### BRIEF DESCRIPTION OF DRAWINGS

FIG. 1 is a cross-sectional view of a rotational drive device including a rotational support device for flying object of a first example of an embodiment of the present disclosure.

FIG. 2 is a cross-sectional view of the rotational support device for flying object of the first example.

FIG. 3 is a perspective view of the rotational support device for flying object of the first example as seen from above.

FIG. 4 is a perspective view of the rotational support device for flying object of the first example as seen from below.

FIG. 5 is a side view of the rotational support device for flying object of the first example as seen from a horizontal direction.

FIG. 6 is a view of the rotational support device for flying object of the first example as seen from above.

FIG. 7 is a view of the rotational support device for flying object of the first example as seen from below.

FIG. 8A is a cross-sectional view of a first another example of an annular member applicable to the rotational support device for flying object of the present disclosure, and FIG. 8B is a view of the annular member as seen from below in FIG. 8A.

FIG. 9A is a cross-sectional view of a second another example of the annular member applicable to the rotational support device for flying object of the present disclosure, and FIG. 9B is a view of the annular member as seen from below in FIG. 9A.

FIG. 10 is a cross-sectional view of a rotational support device for flying object of a second example of an embodiment of the present disclosure.

FIG. 11 is a cross-sectional view of a rotational support device for flying object of a third example of an embodiment of the present disclosure.

FIG. 12 is a cross-sectional view of a rotational support device for flying object of a fourth example of an embodiment of the present disclosure.

FIG. 13 is a cross-sectional view of a rotational support device for flying object of a reference example of the present disclosure.

FIG. 14A to FIG. 14D are schematic cross-sectional views illustrating models of simulations performed to confirm effects of the rotational support device for flying object of the present disclosure.

FIG. 15A to FIG. 15C are graphs illustrating results of bearing performance simulations in pattern 1 of the simulations.

FIG. 16A to FIG. 16C are graphs illustrating results of bearing performance simulations in pattern 2 of the simulations.

FIG. 17A to FIG. 17C are graphs illustrating results of bearing performance simulations in pattern 3 of the simulations.

FIG. 18A and FIG. 18B are graphs illustrating results of bearing performance simulations in pattern 4 of the simulations.

FIG. 19A and FIG. 19B are graphs illustrating results of bearing performance simulations in pattern 5 of the simulations.

FIG. 20A and FIG. 20B are graphs illustrating results of bearing performance simulations in pattern 6 of the simulations.

### DESCRIPTION OF EMBODIMENTS

### First Example

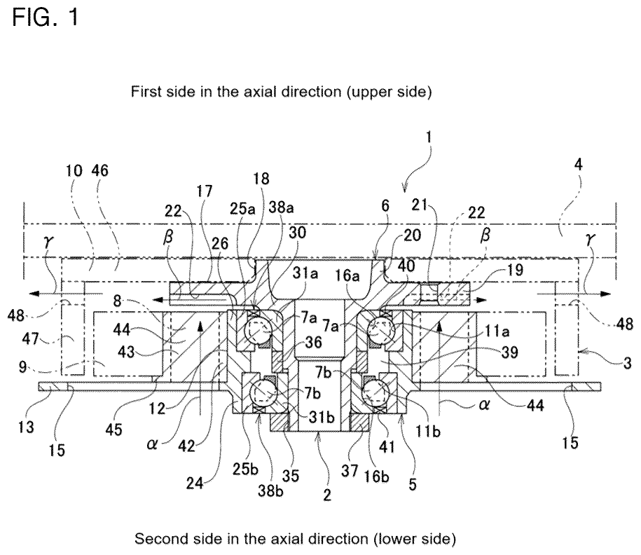

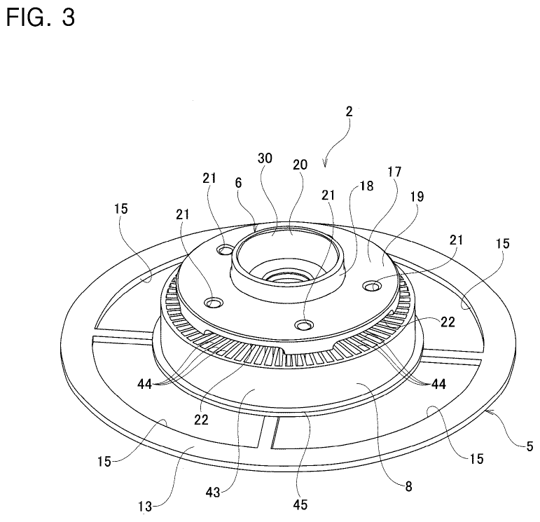

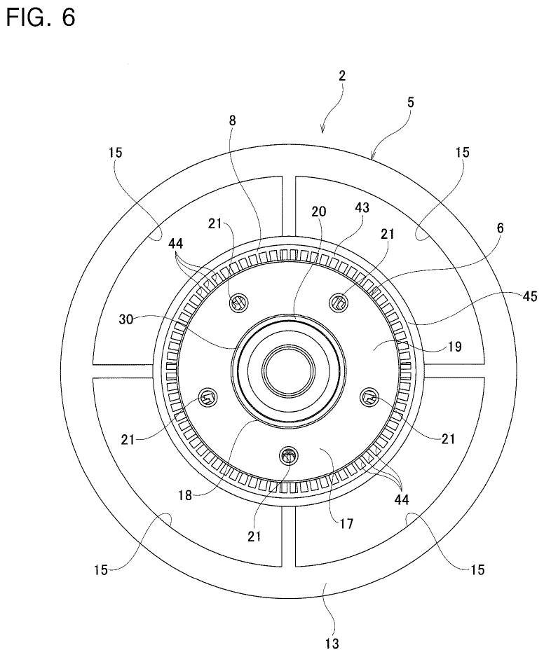

FIG. 1 to FIG. 7 illustrate a rotational support device for flying object of a first example of an embodiment of the present disclosure.

A flying object to which the rotational support device for flying object of the present disclosure can be applied includes an airframe, a propeller for obtaining upward lift, and a rotational drive device for flying object that rotatably supports the propeller with respect to the airframe and rotationally drives the propeller. The flying object may be a large flying object such as a helicopter or a small flying object such as a drone.

The rotational support device for flying object of the present disclosure constitutes a part of the rotational drive device for flying object.

In the present example, as illustrated in FIG. 1, a rotational drive device 1 for flying object includes a rotational support device 2 for flying object and a drive motor 3. The rotational support device 2 for flying object rotatably supports a propeller 4 with respect to an airframe. The drive motor 3 generates rotational force for rotationally driving the propeller 4.

The rotational support device 2 for flying object includes a stationary body 5, a rotating body 6, and a plurality of balls 7a, 7b. In the present example, in an assembled state of the flying object, the stationary body 5 is supported by the airframe and does not rotate, and the rotating body 6 supports the propeller 4 and rotates integrally with the propeller 4. The plurality of balls 7a, 7b rotatably support the rotating body 6 with respect to the stationary body 5.

The drive motor 3 includes a motor stator 9 and a motor rotor 10. The motor stator 9 is supported by the stationary body 5. The motor rotor 10 is supported by the rotating body 6 so as to face the motor stator 9.

The rotational support device 2 for flying object and the drive motor 3 of the present example will be described in more detail below.

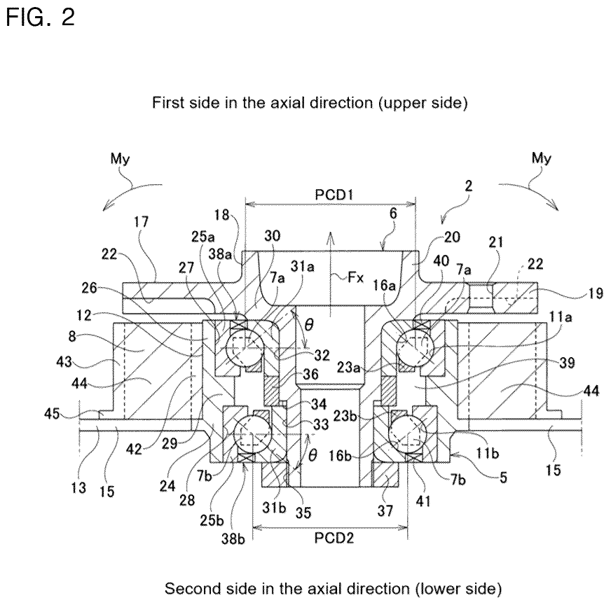

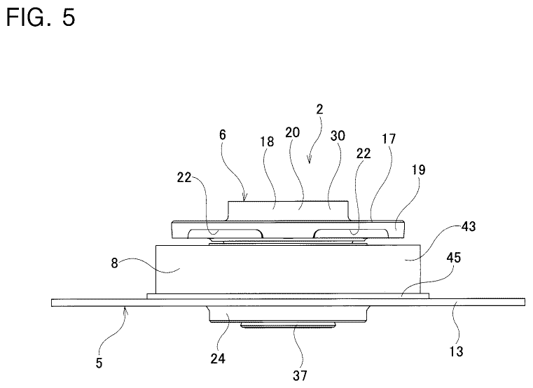

In the description of the present example regarding the rotational support device 2 for flying object, a first side in the axial direction is a side on which the propeller 4 is arranged in an assembled state of the flying object, that is, the upper side in FIG. 1, FIG. 2, and FIG. 5.

The stationary body 5 has double-row outer ring raceways 11a, 11b on an inner circumferential surface thereof.

Each of the double-row outer ring raceways 11a, 11b is an angular type. In the present example, the stationary body 5 has a groove shoulder portion on the inner circumferential surface in a portion adjacent to the second side in the axial direction of the first outer ring raceway 11a on the first side in the axial direction, the groove shoulder portion largely protruding toward a radial inner side compared with a portion adjacent to the first side in the axial direction of the first outer ring raceway 11a. Further, the stationary body 5 has a groove shoulder portion on the inner circumferential surface in a portion adjacent to the first side in the axial direction of the second outer ring raceway 11b on the second side in the axial direction, the groove shoulder portion largely protruding toward the radial inner side compared with a portion adjacent to the second side in the axial direction of the second outer ring raceway 11b.

In a case of implementing the rotational support device for flying object of the present disclosure, each of the outer ring raceways 11a, 11b can be formed on the stationary body 5 itself, or can be formed on the outer rings that compose the stationary body 5 and are assembled to the stationary body 5.

In the present example, the stationary body 5 is composed of a stationary side support member 24 and a first outer ring 25a and a second outer ring 25b internally fitted to the stationary side support member 24. The first outer ring raceway 11a is provided on an inner circumferential surface of the first outer ring 25a, and the second outer ring raceway 11b is provided on an inner circumferential surface of the second outer ring 25b.

In a case of implementing the rotational support device for flying object of the present disclosure, the first outer ring and the second outer ring can be arranged separated from each other in the axial direction, or can be arranged adjacent to each other in the axial direction.

In the present example, in order to increase the axial spacing between the double-row outer ring raceways 11a, 11b so as to make it easier to ensure moment rigidity (tilt rigidity) of the rotational support device 2 for flying object, the first outer ring 25a and the second outer ring 25b are arranged separated from each other in the axial direction.

In the present example, in order to maintain spacing width in the axial direction of the first outer ring 25a and the second outer ring 25b at a constant size, a configuration is adopted in which an inward flange-shaped protrusion 29 provided on the stationary side support member 24 is held from both sides in the axial direction by the first outer ring 25a and the second outer ring 25b.

The rotating body 6 has double-row inner ring raceways 16a, 16b on an outer circumferential surface thereof.

Each of the double-row inner ring raceways 16a, 16b is an angular type. In the present example, the rotating body 6 has a groove shoulder portion on the outer circumferential surface in a portion adjacent to the first side in the axial direction of the first inner ring raceway 16a on the first side in the axial direction, the groove shoulder portion largely protruding toward the radial outer side compared with a portion adjacent to the second side in the axial direction of the first inner ring raceway 16a. Further, the rotating body 6 has a groove shoulder portion on the outer circumferential surface in a portion adjacent to the second side in the axial direction of the second inner ring raceway 16b on the second side in the axial direction, the groove shoulder portion largely protruding toward the radial outer side compared with a portion adjacent to the first side in the axial direction of the second inner ring raceway 16b.

In a case of implementing the rotational support device for flying object of the present disclosure, each of the inner ring raceways 16a, 16b can be formed on the rotating body 6 itself, or can be formed on inner rings that compose the rotating body 6 and are assembled to the rotating body 6.

In the present example, the rotating body 6 is composed of a rotating side support member 30 and a first inner ring 31a and a second inner ring 31b externally fitted to the rotating side support member 30. The first inner ring raceway 16a is provided on an outer circumferential surface of the first inner ring 31a, and the second inner ring raceway 16b is provided on an outer circumferential surface of the second inner ring 31b.

In a case of implementing the rotational support device for flying object of the present disclosure, the first inner ring and the second inner ring can be arranged separated from each other in the axial direction, or can be arranged adjacent to each other in the axial direction.

In the present example, in order to increase the axial spacing between the double-row inner ring raceways 16a, 16b so as to make it easier to ensure moment rigidity of the rotational support device 2 for flying object, the first inner ring 31a and the second inner ring 31b are arranged separated from each other in the axial direction.

In the present example, the rotating body 6 further includes a cylindrical spacer 36. In the present example, in order to maintain spacing width in the axial direction of the first inner ring 31a and the second inner ring 31b at a constant size, a configuration is adopted in which the spacer 36 is held from both sides in the axial direction by the first inner ring 31a and the second inner ring 31b.

The balls 7a, 7b are made of metal such as an iron alloy or made of ceramics, and the plurality of balls are arranged in each row between the double-row outer ring raceways 11a, 11b and the double-row inner ring raceways 16a, 16b with a contact angle θ of a back-to-back type (DB type) and with preload applied. The balls 7a, 7b of each row are held by cages 23a, 23b so as to be able to freely roll.

In a case of implementing the rotational support device for flying object of the present disclosure, the magnitude of the contact angle θ is not particularly limited, but from the aspect of ensuring bearing performance of a pair of angular ball bearings, it is preferably 30° or more and 45° or less, and more preferably 40° or more and 45° or less. In the present example, the magnitude of the contact angle is set to approximately 40°.

In the present example, in an assembled state of the rotational support device 2 for flying object, configurations and dimensions of parts of the stationary body 5 and the rotating body 6 are regulated such that the balls 7a, 7b of each row are applied with a predetermined amount of preload.

In the present example, the first outer ring 25a, the first inner ring 31a, and the plurality of first balls 7a are combined to form a first angular ball bearing 38a, and the second outer ring 25b, the second inner ring 31b, and the plurality of second balls 7b are combined to form a second angular ball bearing 38b. The rotating side support member 30 is rotatably supported on the radial inner side of the stationary side support member 24 by using the first angular ball bearing 38a and the second angular ball bearing 38b.

In the rotational support device 2 for flying object of the present example, PCD1, which is a pitch circle diameter (PCD) of the first balls 7a, and PCD2, which is a pitch circle diameter of the second balls 7b, are different from each other.

A size relationship between PCD1 and PCD2 is appropriately determined in one step of a method for manufacturing the rotational support device for flying object of the present disclosure, in accordance with load conditions acting on the rotating body when the rotational support device for flying object to be manufactured is assembled to and used in the flying object.

That is, the rotational support device for flying object of the present disclosure is used under the following load condition 1 or 2 with respect to load conditions acting on the rotating body.
Load condition 1: Axial load Fx+Moment load My
Load condition 2: Axial load Fx only

The axial load Fx acts as lift directed to the first side in the axial direction, which is generated along with rotation of the propeller 4. Further, the moment load My acts, for example, when a flying object moves horizontally during flight.

Furthermore, in the rotational support device for flying object of the present disclosure, when used under the load condition 1, by making PCD2 smaller than PCD1, it is possible to efficiently achieve downsizing of the rotational support device for flying object while ensuring bearing performance of the pair of angular ball bearings, specifically rotational efficiency (low heat generation), moment rigidity, and L10 life (see description of “Examples” described later).

In contrast, in the rotational support device for flying object of the present disclosure, when used under the load condition 2, by making PCD1 smaller than PCD2, it is possible to efficiently achieve downsizing of the rotational support device for flying object while ensuring bearing performance of the pair of angular ball bearings, specifically rotational efficiency (low heat generation) and L10 life (see description of “Examples” described later). In a case of being used under the load condition 2, the reason why moment rigidity is not considered as bearing performance is that substantially no moment load acts on the rotating body, in other words, high moment rigidity is not required for the rotational support device for flying object.

Accordingly, in a method for manufacturing the rotational support device for flying object of the present disclosure, when the rotational support device for flying object to be manufactured is used under the load condition 1, a decision is made to adopt a configuration in which PCD2 is made smaller than PCD1, and when the rotational support device for flying object to be manufactured is used under the load condition 2, a decision is made to adopt a configuration in which PCD1 is made smaller than PCD2. This makes it possible to efficiently achieve downsizing of the rotational support device for flying object while ensuring bearing performance of the pair of angular ball bearings.

Since the rotational support device 2 for flying object of the present example is used under the load condition 1, a configuration in which PCD2 is made smaller than PCD1 (PCD1 >PCD2) is adopted.

In a case of implementing the structure of the present example, as long as bearing performance required for the pair of angular ball bearings 38a, 38b can be ensured, from the aspect of achieving downsizing of the device, a difference (PCD2−PCD1) between the pitch circle diameter PCD1 of the first balls 7a and the pitch circle diameter PCD2 of the second balls 7b can be set to any size.

Further, in the present example, as a result of adopting a configuration in which PCD2 is made smaller than PCD1, an outer diameter of the second outer ring 25b is made smaller than an outer diameter of the first outer ring 25a, and an inner diameter of the second inner ring 31b is made smaller than an inner diameter of the first inner ring 31a.

For this reason, in the present example, in the stationary side support member 24, an inner diameter of a second outer ring fitting portion 28 to which the second outer ring 25b is internally fitted is made smaller than an inner diameter of a first outer ring fitting portion 27 to which the first outer ring 25a is internally fitted. Further, in the rotating side support member 30, an outer diameter of a second inner ring fitting portion 33 to which the second inner ring 31b is externally fitted is made smaller than an outer diameter of a first inner ring fitting portion 32 to which the first inner ring 31a is externally fitted.

The stationary body 5 and the rotating body 6 are not limited to the structure of the present example, but in the present example, the stationary body 5 and the rotating body 6 have the following specific configurations.

In the present example, the stationary body 5 is, for example, made of metal such as an iron alloy, and has an annular shape as a whole.

In the present example, the rotational support device 2 for flying object further includes, as an optional component, an annular member 8 that is externally fitted to the stationary body 5. Accordingly, in the present example, the stationary body 5 has a stationary fitting portion 12 for externally fitting the annular member 8 thereto. Further, the stationary body 5 has a stationary flange 13 used for supporting and fixing the stationary body 5 to an airframe. In the present example, as described later, the motor stator 9 is attached to the stationary body 5 through the annular member 8.

In the present example, the stationary fitting portion 12 and the stationary flange 13 are provided on the stationary side support member 24.

Specifically, the stationary side support member 24 includes a stationary side cylindrical portion 26 having the stationary fitting portion 12 on a portion in the axial direction of an outer circumferential surface thereof, and a stationary flange 13 that protrudes toward the outside in the radial direction from a portion in the axial direction of the stationary side cylindrical portion 26.

The stationary fitting portion 12 is provided on a portion of the outer circumferential surface of the stationary side cylindrical portion 26 located further to the first side in the axial direction than the stationary flange 13, specifically, on a portion extending from an end portion on the first side in the axial direction to a middle portion in the axial direction, and is formed by a cylindrical surface.

The first outer ring fitting portion 27 to which the first outer ring 25a is internally fitted is provided at an end portion on the first side in the axial direction of the inner circumferential surface of the stationary side cylindrical portion 26. The second outer ring fitting portion 28 to which the second outer ring 25b is internally fitted is provided at an end portion on the second side in the axial direction of the inner circumferential surface of the stationary side cylindrical portion 26. The first outer ring fitting portion 27 and the second outer ring fitting portion 28 are each formed by a cylindrical surface.

The protrusion 29 is provided so as to protrude toward the radial inner side from a portion between the first outer ring fitting portion 27 and the second outer ring fitting portion 28 in the axial direction of the stationary side cylindrical portion 26.

The first outer ring 25a is internally fitted to the first outer ring fitting portion 27 and is positioned in the axial direction by abutting an end surface on the second side in the axial direction thereof against an end surface on the first side in the axial direction of the protrusion 29.

The second outer ring 25b is internally fitted to the second outer ring fitting portion 28 and is positioned in the axial direction by abutting an end surface on the first side in the axial direction thereof against an end surface on the second side in the axial direction of the protrusion 29.

The stationary flange 13 protrudes toward the outside in the radial direction from a portion of the stationary side cylindrical portion 26 adjacent to the second side in the axial direction of the stationary fitting portion 12, that is, from an end portion on the second side in the axial direction of the stationary side cylindrical portion 26.

In the present example, an outer diameter of the stationary flange 13 is larger than an outer diameter of the motor rotor 10.

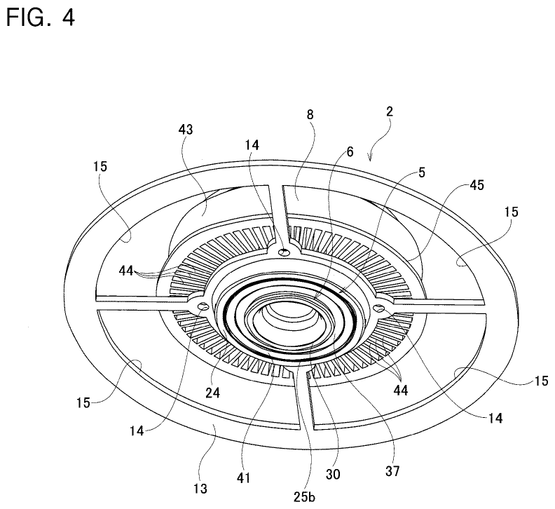

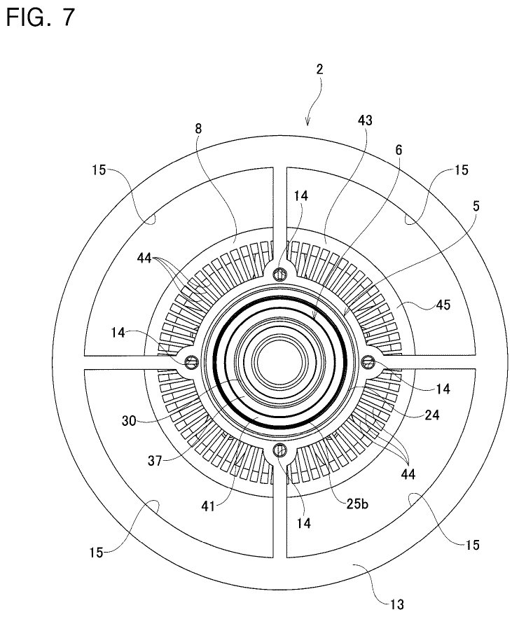

In the present example, the stationary flange 13 has support holes 14 that penetrate in the axial direction in a plurality of locations in the circumferential direction of an inner end portion in the radial direction thereof (see FIG. 4 and FIG. 7). The support holes 14 are used to support and fix the stationary body 5 to the airframe. In the present example, the support holes 14 are formed as screw holes. In the illustrated example, the number of the support holes 14 is four, however, in a case of implementing the rotational support device for flying object of the present disclosure, the number of the support holes may be made different from that in the present example.

In the present example, the stationary flange 13 has window holes 15 that penetrate in the axial direction in a plurality of locations in the circumferential direction of a middle portion in the radial direction thereof. The window holes 15 are used for ventilation and the like. In the present example, each window hole 15 has a fan shape centered around a central axis of the stationary body 5 when viewed from the axial direction. In the illustrated example, the number of the window holes 15 is four, however, in a case of implementing the rotational support device for flying object of the present disclosure, the number of the window holes may be made different from that in the present example.

In a case of implementing the rotational support device for flying object of the present disclosure, each window hole 15 provided in the stationary flange 13 may also be covered with a fine mesh. By doing so, it is possible to ensure the ventilation of the window holes 15 and to prevent the entry of dust from below by the mesh.

Bolts inserted through through-holes provided in the airframe are screwed into the support holes 14 of the stationary flange 13 from the second side in the axial direction to support and fix the stationary body 5 to the airframe, and the stationary body 5 does not rotate even when the propeller 4 rotates.

In a case of implementing the rotational support device for flying object of the present disclosure, each support hole may be configured by a through hole, and the bolts inserted through each of the support holes may be screwed into screw holes provided in the airframe, thereby supporting and fixing the stationary body to the airframe. Further, the position in the radial direction of each support hole may also be made different from that in the present example. For example, the position in the radial direction of each support hole may also be set to a position on the outside in the radial direction of the motor stator or the motor rotor.

In the present example, the stationary body 5 has a configuration in which the stationary flange 13 and a portion to which an inner end portion in the radial direction of the stationary flange 13 is connected (in the present example, the stationary side cylindrical portion 26) are integrally formed. However, in a case of implementing the rotational support device for flying object of the present disclosure, a configuration may also be adopted in which the stationary flange and the portion to which the inner end portion in the radial direction of the stationary flange is connected are manufactured as separate parts and then the parts are connected and fixed to each other. Further, in a case of implementing the rotational support device for flying object of the present disclosure, when the stationary body is supported and fixed to the airframe in a method different from the present example, the stationary flange may be omitted.

In the present example, although a configuration is adopted in which the stationary body 5 is directly supported and fixed to the airframe, in a case of implementing the rotational support device for flying object of the present disclosure, a configuration may also be adopted in which the stationary body is supported and fixed to the airframe through an annular member externally fitted and fixed to a stationary side fitting portion of the stationary body. In this case, a flange, support holes, or the like serving as a mounting portion to the airframe may be provided in a part of the annular member.

In the present example, the rotating body 6 is a shaft member made of metal such as an iron alloy, and is arranged on the inside in the radial direction of the stationary body 5 so as to be coaxial with the stationary body 5.

In the present example, the rotating body 6 has a rotor abutment portion 17 provided at a portion located further to the first side in the axial direction than the stationary body 5 for bringing the motor rotor 10 into contact in the axial direction therewith, and a rotor fitting portion 18 provided at a portion located further to the first side in the axial direction than the stationary body 5 for externally fitting the motor rotor 10 thereto.

In the present example, the rotor abutment portion 17 and the rotor fitting portion 18 are provided on the rotational support member 30.

Specifically, the rotating side support member 30 has a rotating flange 19 protruding toward the outside in the radial direction at a portion located further to the first side in the axial direction than the stationary body 5. The rotating flange 19 has a hollow disk shape. The rotor abutment portion 17 is provided on a side surface on the first side in the axial direction of the rotating flange 19.

The rotating side support member 30 has a pilot portion 20 at an end portion on the first side in the axial direction. In the present example, the pilot portion 20 has a cylindrical shape protruding to the first side in the axial direction from an inner end portion in the radial direction of the rotating flange 19. The rotor fitting portion 18 is provided on an outer circumferential surface of the pilot portion 20.

In the present example, an outer diameter of the rotating flange 19 is larger than an outer diameter of the stationary fitting portion 12 and equal to or smaller than an outer diameter of the annular member 8 externally fitted to the stationary fitting portion 12. More specifically, in the present example, the outer diameter of the rotating flange 19 is slightly smaller than the outer diameter of the annular member 8. For this reason, after assembling the rotational support device 2 for flying object, the annular motor stator 9 can be externally fitted to the annular member 8 from the first side in the axial direction.

In a case of implementing the rotational support device for flying object of the present disclosure, an outer diameter of the rotating flange may also be made equal to or smaller than an outer diameter of the stationary fitting portion. As a result, after assembling the stationary body, the rotating body, and the plurality of balls together, the annular member can be externally fitted to the stationary fitting portion.

In the present example, the rotating flange 19 has mounting holes 21 that penetrate in the axial direction in a plurality of locations in the circumferential direction of a middle portion in the radial direction thereof. The mounting holes 21 are used for connecting and fixing the motor rotor 10 to the rotating flange 19. In the present example, the mounting holes 21 are formed as screw holes. In the illustrated example, the number of the mounting holes 21 is five, however, in a case of implementing the rotational support device for flying object of the present disclosure, the number of the mounting holes may be made different from that in the present example.

In the present example, the rotating flange 19 has flange recess portions 22 that open to the second side in the axial direction and to the outside in the radial direction at a plurality of locations in the circumferential direction. In the present example, the flange recesses portions 22 are arranged at five locations so as to be uniformly spaced in the circumferential direction. The flange recess portions 22 are used to generate an airflow around the periphery when the rotating body 6 rotates. End portions on the inner side in the radial direction of the flange recess portions 22 are located on the inner side in the radial direction of the stationary fitting portion 12 respectively. End portions on the outer side in the radial direction of the flange recess portions 22 are located on the outer side in the radial direction of the stationary fitting portion 12 respectively.

In the present example, the flange recess portions 22 are arranged at positions in the circumferential direction offset from the mounting holes 21 respectively. That is, in the rotating flange 19, the mounting holes 21 and the flange recess portions 22 are alternately arranged in the circumferential direction. In the present example, each bottom surface in the axial direction of the flange recess portions 22 is formed by a flat surface perpendicular to the axial direction of the rotating body 6. However, in a case of implementing the rotational support device for flying object of the present disclosure, the bottom surfaces in the axial direction of the flange recess portions may also be inclined with respect to an imaginary flat plane perpendicular to the axial direction of the rotating body.

The first inner ring fitting portion 32 to which the first inner ring 31a is externally fitted and the second inner ring fitting portion 33 to which the second inner ring 31b is externally fitted are provided at a middle portion in the axial direction of an outer circumferential surface of the rotating side support member 30. The first inner ring fitting portion 32 and the second inner ring fitting portion 33 are each formed by a cylindrical surface. In the present example, the rotating side support member 30 has a stepped surface 34 facing the second side in the axial direction at an end portion on the first side in the axial direction of the second inner ring fitting portion 33. Further, the rotating side support member 30 has a male screw portion 35 at an end portion on the second side in the axial direction of the outer circumferential surface thereof.

The first inner ring 31a is externally fitted to the first inner ring fitting portion 32 and is positioned in the axial direction by abutting an end surface on the first side in the axial direction thereof against a side surface on the second side in the axial direction of the rotating flange 19.

The spacer 36 is externally fitted to a portion of the first inner ring fitting portion 32 located further to the second side in the axial direction than the first inner ring 31a, and an end surface on the first side in the axial direction thereof is brought into contact with an end surface on the first side in the axial direction of the first inner ring 31a.

The second inner ring 31b is externally fitted to the second inner ring fitting portion 33 and is positioned in the axial direction by abutting an end surface on the first side in the axial direction thereof against an end surface on the second side in the axial direction of the spacer 36.

In this state, the end surface on the second side in the axial direction of the spacer 36 is arranged further to the second side in the axial direction than the stepped surface 34. That is, in the present example, the end surface on the first side in the axial direction of the second inner ring 31b, which abuts the end surface on the second side in the axial direction of the spacer 36, does not abut the stepped surface 34.

In the present example, the rotating side support member 30 further includes a nut 37, and the end surface on the second side in the axial direction of the second inner ring 31b is pressed by the nut 37 screwed and tightened onto the male screw portion 35. Further, by regulating the tightening amount of the nut 37, a predetermined amount of preload is applied to the balls 7a, 7b in the assembled state of the rotational support device 2 for flying object.

In a case of implementing the rotational support device for flying object of the present disclosure, the end surface on the second side in the axial direction of the second inner ring may also be pressed by a crimped portion provided at an end portion on the second side in the axial direction of the rotating side support member instead of a nut.

In the present example, the rotating body 6 has a hollow structure provided with a central hole penetrating in the axial direction at a central portion in the radial direction for weight reduction and ventilation. For this reason, specifically, the rotating side support member 30 has a hollow structure provided with a central hole penetrating in the axial direction at a central portion in the radial direction. However, in a case of implementing the rotational support device for flying object of the present disclosure, the rotating body may also have a solid structure without a central hole penetrating in the axial direction.

The rotational support device 2 for flying object of the preset example further includes a first-side seal device 40 that closes an opening on the first side in the axial direction of a rolling element installation space 39 located between the inner circumferential surface of the stationary body 5 and the outer circumferential surface of the rotating body 6, and a second-side seal device 41 that closes an end portion on the second side in the axial direction of the rolling element installation space 39. Due to this, it is possible to prevent foreign matters in the external space from entering the rolling element installation space 39 through the openings on both sides in the axial direction of the rolling element installation space 39, and to prevent grease filled in the rolling element installation space 39 from leaking into the external space.

The first-side seal device 40 and the second-side seal device 41 may be configured, for example, by contact-type seal rings that are supported and fixed to the stationary body 5 and that have seal lips with tip end portions brought into sliding contact with a surface of the rotating body 6 over the entire circumference. The first-side seal device 40 and the second-side seal device 41 may further respectively include a sliding contact rings that is supported and fixed to the rotating body 6 and has a surface with which a tip end portion of each of the seal lips into sliding contact. In the present example, the first-side seal device 40 is assembled to an opening on the first side in the axial direction of the first angular ball bearing 38a, and the second-side seal device 41 is assembled to an opening on the second side in the axial direction of the second angular ball bearing 38b.

Alternatively, in a case of implementing the rotational support device for flying object of the present disclosure, instead of providing the second-side seal device 41, a configuration may be adopted in which a bearing cap that closes an opening at an end portion on the second side in the axial direction of the stationary body 5 is provided. In this case, in order to prevent communication between the rolling element installation space 39 and the external space, it is preferable to provide a separate closing member that closes the central hole of the rotating body, or to make the rotating body a solid structure that does not include a central hole penetrating in the axial direction.

In the present example, the annular member 8 has a function as a base for ensuring a large outer diameter dimension of the motor stator 9 while keeping the width dimension in the radial direction of the motor stator 9 small.

That is, in the present example, the motor stator 9 is externally fitted to the stationary body 5 through the annular member 8. Therefore, compared to a case where the motor stator 9 is directly externally fitted to the stationary body 5, it is possible to ensure a large outer diameter dimension of the motor stator 9 while keeping a width dimension in the radial direction of the motor stator 9 small. In the present example, by ensuring a large outer diameter dimension of the motor stator 9, output of the drive motor 3, specifically, an electromagnetic force for rotating the motor rotor 10 with respect to the motor stator 9, can be ensured to be large.

In the present example, the annular member 8 further has a function as a heat exchange member, such as a heat dissipating fin, that efficiently receives heat from the adjacent motor stator 9 and efficiently performs heat exchange with the surrounding air, in order to facilitate cooling of the drive motor 3.

For this reason, in the present example, the annular member 8 is made of a metal having high thermal conductivity, such as a copper alloy, an aluminum alloy, or an iron alloy. Further, the annular member 8 has a structure suitable for ensuring a large contact area with the surrounding air, specifically, a structure that has a plurality of (many) ventilation passages for allowing air to pass through in the axial direction.

In the present example, the annular member 8 includes an inner diameter side cylindrical portion 42, an outer diameter side cylindrical portion 43, and a plurality of (many) connecting portions 44. The inner diameter side cylindrical portion 42 has a cylindrical shape. The outer diameter side cylindrical portion 43 has a cylindrical shape and is arranged on the outer side in the radial direction of the inner diameter side cylindrical portion 42 so as to be coaxial with each other.

The plurality of connecting portions 44 are uniformly spaced in the circumferential direction between the outer circumferential surface of the inner diameter side cylindrical portion 42 and the inner circumferential surface of the outer diameter side cylindrical portion 43, and each has a flat plate shape extending in the radial direction and the axial direction. Inner end portions in the radial direction of the connecting portions 44 are respectively connected to the outer circumferential surface of the inner diameter side cylindrical portion 42, and outer end portions in the radial direction of the connecting portions 44 are respectively connected to the inner circumferential surface of the outer diameter side cylindrical portion 43. In the present example, the connecting portions 44 function as fin portions for heat exchange, and spaces between the connecting portions 44 that are adjacent in the circumferential direction form ventilation passages in the axial direction.

In the present example, the outer diameter side cylindrical portion 43 has an outward flange portion 45 protruding toward the outside in the radial direction at an end portion on the second side in the axial direction. The outward flange portion 45 is used to position the motor stator 9 in the axial direction with respect to the annular member 8.

In the present example, the annular member 8 is press-fitted onto the stationary fitting portion 12 of the stationary body 5 to be fixed to the stationary body 5, and is positioned in the axial direction with respect to the stationary body 5 by bringing a side surface on the second side in the axial direction into contact with a side surface on the first side in the axial direction of the stationary flange 13.

In a case of implementing the rotational support device for flying object of the present disclosure, fixing methods for the annular member 8 externally fitted to the stationary fitting portion 12 of the stationary body are not limited to the fixing method of the present example, and various fixing methods can be adopted including connecting and fastening using bolts, key press-fitting, pin press-fitting, serration press-fitting, and adhesion.

In the structure of the present example, since the outer diameter of the rotating flange 19 is larger than the outer diameter of the stationary fitting portion 12, after the stationary body 5 and the rotating body 6 are assembled together with the plurality of first balls 7a and second balls 7b, the rotating flange 19 becomes an obstacle, making it impossible to externally fit the annular member 8 onto the stationary fitting portion 12. For this reason, in the present example, the annular member 8 is externally fitted to the stationary fitting portion 12 in a state before the stationary body 5 and the rotating body 6 are assembled together with the plurality of first balls 7a and second balls 7b.

In the present example, in a state where the annular member 8 is externally fitted and fixed to the stationary fitting portion 12 of the stationary body 5, inner side portions in the radial direction of the respective window holes 15 of the stationary flange 13 are arranged so as to be overlapped in the axial direction with the connecting portions 44 of the annular member 8.

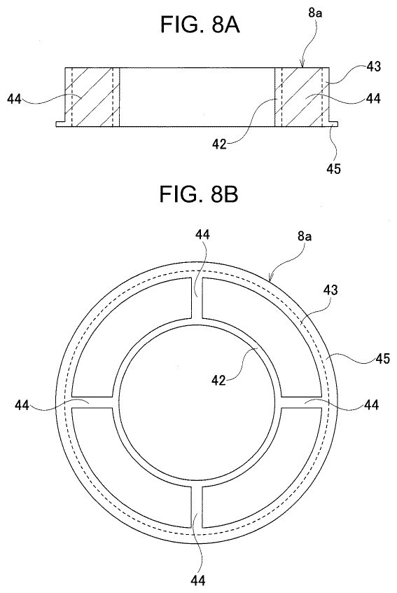

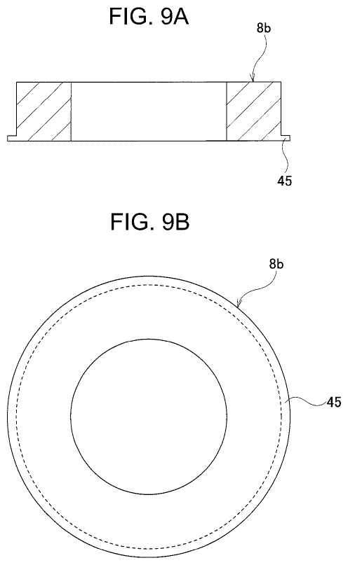

In a case of implementing the rotational support device for flying object of the present disclosure, an annular member having substantially no function as a heat exchange member may be adopted. In this case, the annular member may be made of a non-metallic material, for example, a synthetic resin such as carbon fiber reinforced plastic. Further, as the annular member, an annular member 8a having a smaller number of connecting portions 44 than that of the present example (four in the illustrated example) as illustrated in FIG. 8A and FIG. 8B, or an annular member 8b having no ventilation passages in the axial direction as illustrated in FIG. 9A and FIG. 9B may also be used. Furthermore, in a case of implementing the rotational support device for flying object of the present disclosure, it is also possible to integrally make various types of annular members with the stationary side support member, that is, the annular member and the stationary side support member may be formed as a single part.

In the present example, the motor stator 9 includes a core made of a magnetic material and a coil wound around the core, is configured in an annular shape as a whole, with magnetic poles at a plurality of locations uniformly spaced in the circumferential direction on an outer circumferential surface. The motor stator 9 is externally fitted and fixed to the outer circumferential surface of the annular member 8 by press-fitting or the like, and is positioned in the axial direction with respect to the annular member 8 by bringing a radially inner end portion of a side surface on the second side in the axial direction into contact with a side surface on the first side in the axial direction of an outward flange portion 45 of the annular member 8.

In the present example, the motor rotor 10 includes a hollow disk-shaped side plate portion 46 and a cylindrical tubular portion 47 extending toward the second side in the axial direction from a radially outer end portion of the side plate portion 46. The tubular portion 47 has ventilation holes 48 penetrating in the radial direction at a plurality of locations in the circumferential direction of an end portion on the first side in the axial direction, and has magnets at a plurality of locations uniformly spaced in the circumferential direction of a radially inner end portion of a portion on the second side in the axial direction.

The motor rotor 10 is connected and fixed to the rotating flange 19 by screwing bolts, which are inserted into through holes provided at a plurality of locations in the circumferential direction of the side plate portion 46, into the mounting holes 21 of the rotating flange 19, in a state where the motor rotor 10 is positioned in the radial direction and the axial direction with respect to the rotating body 6 by externally fitting the side plate portion 46 to the rotor fitting portion 18 without looseness in the radial direction and bringing a radially inner portion of a side surface on the second side in the axial direction of the side plate portion 46 into contact with the rotor abutment portion 17. In this state, the plurality of magnets provided on an inner circumferential surface of the tubular portion 47 of the motor rotor 10 are closely opposed in the radial direction to the plurality of magnetic poles provided on an outer circumferential surface of the motor stator 9.

Alternatively, the mounting holes of the rotating flange may be formed as press-fit holes, and the motor rotor may be connected and fixed to the rotating flange by screwing nuts onto tip end portions of stud bolts press-fitted into the press-fit holes and inserted into the through holes of the side plate portion.

In the present example, the propeller 4 is connected and fixed to the rotating body 6 through the motor rotor 10 with the central axis of rotation of the propeller 4 aligned with the central axis of the rotating body 6 and a side surface on the second side in the axial direction of a portion around the central axis of rotation of the propeller 4 coming in contact with the side surface on the first side in the axial direction of the side plate portion 46 of the motor rotor 10, by screwing bolts which are inserted into through holes provided at a plurality of locations in the circumferential direction of the propeller 4 into screw holes provided at a plurality of locations in the circumferential direction of the side plate portion 46.

In this state, by energizing the coil of the motor stator 9 and generating an electromagnetic force between the plurality of magnetic poles of the motor stator 9 and the plurality of magnets of the motor rotor 10 to rotate the motor rotor 10 with respect to the motor stator 9, the rotating body 6 and the propeller 4 are rotationally driven.

In the present example, when the rotating body 6 rotates, air present inside each of the flange recess portions 22 of the rotating flange 19 is pushed toward outside in the radial direction by the action of centrifugal force. That is, the rotating flange 19 including the plurality of flange recess portions 22 has a pumping function to generate an air flow around the periphery thereof.

Due to this pumping function, in the present example, when the rotating body 6 rotates, air present below the rotation support device 2 for flying object is drawn upward as indicated by an arrow α in FIG. 1 through each of the window holes 15 of the stationary flange 13, and passes between the connecting portions 44 adjacent to each other in the circumferential direction of the annular member 8 from below to above. The air that has passed through enters inside of each of the flange recess portions 22 of the rotating flange 19 and is pushed toward outside in the radial direction by the action of centrifugal force as indicated by an arrow β in FIG. 1.

Furthermore, the air that is pushed out is discharged to a space on the outside in the radial direction of the motor rotor 10 through the ventilation holes 48 of the motor rotor 10, as indicated by an arrow γ in FIG. 1. In this manner, in the structure of the present example, heat dissipation of the annular member 8 is efficiently performed by the air flowing in the directions of the arrows α, β, and γ, so that the drive motor 3 is efficiently cooled.

However, in a case of implementing the rotational support device for flying object of the present disclosure, it is not essential that the rotating flange of the rotating body have a pumping function, and the flange recess portions of the rotating flange may be omitted.

The rotational support device 2 for flying object of the present example is used under conditions where both the axial load Fx and the moment load My act on the rotating body 6, and adopts a configuration in which the pitch circle diameter PCD2 of the second balls 7b is smaller than the pitch circle diameter PCD1 of the first balls 7a (PCD2<PCD1). For this reason, while ensuring bearing performance of the pair of angular ball bearings 38a, 38b, specifically rotational efficiency (low heat generation), moment rigidity, and L10 life, downsizing of the rotational support device 2 for flying object can be efficiently achieved.

### Second Example

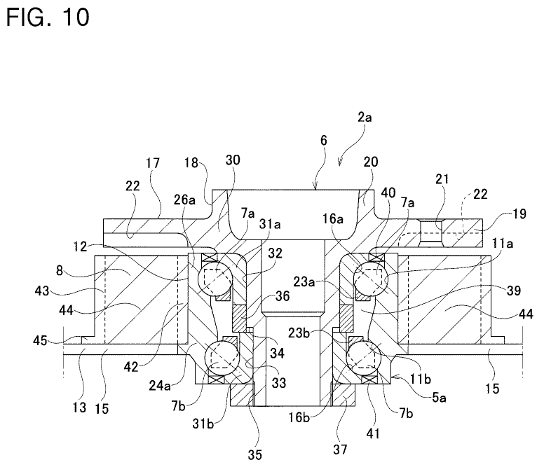

FIG. 10 illustrates a rotational support device for flying object of a second example of an embodiment of the present disclosure.

In the rotational support device 2a for flying object of the present example, the stationary body 5a is composed only of a stationary side support member 24a. That is, the stationary body 5a does not include a first outer ring and a second outer ring fitted into the stationary side support member 24a, and a first outer ring raceway 11a and a second outer ring raceway 11b are directly formed on an inner circumferential surface of a stationary side cylindrical portion 26a of the stationary side support member 24a.

In the present example, since the first outer ring raceway 11a and the second outer ring raceway 11b are directly formed on the inner circumferential surface of the stationary side support member 24a, the outer diameter of the cylindrical portion of the stationary side support member 24a can be made smaller than that of the first example, thereby achieving downsizing and weight reduction of the rotational support device 2a for flying object. In addition, since the first outer ring and the second outer ring can be omitted, the number of parts can be reduced. Other configurations and effects of the present example are the same as those of the first example.

### Third Example

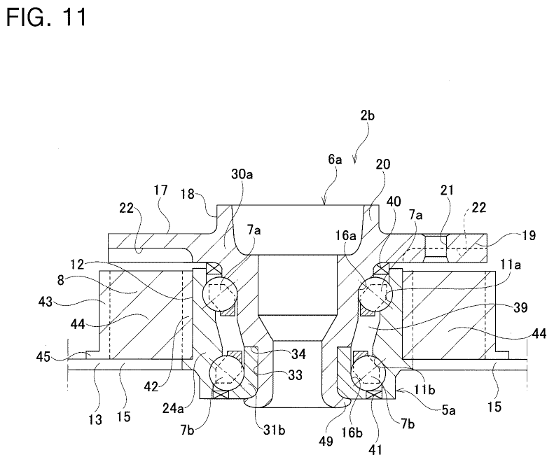

FIG. 11 illustrates a rotational support device for flying object of a third example of an embodiment of the present disclosure.

In the rotational support device 2b for flying object of the present example, the rotating body 6a is formed by combining a rotating side support member 30a and a second inner ring 31b. That is, the rotating body 6a does not include a first inner ring externally fitted to the rotating side support member 30a, and a first inner ring raceway 16a is directly formed on an outer circumferential surface of the rotating side support member 30a.

In the present example, the rotating side support member 30a has a crimped portion 49 bent toward the outside in the radial direction at an end portion on the second side in the axial direction thereof. The rotating body 6a is formed by externally fitting the second inner ring 31b to a second inner ring fitting portion 33 of the rotating side support member 30a and holding the second inner ring 31b from both sides in the axial direction between a stepped surface 34 of the rotating side support member 30a and the crimped portion 49, thereby connecting and fixing the rotating side support member 30a and the second inner ring 31b. That is, in the present example, a nut for pressing an end surface of the inner side in the axial direction of the second inner ring 31b is omitted.

In the present example, since the first inner ring raceway 16a is directly formed on the outer circumferential surface of the rotating side support member 30a, an inner diameter at the same position in the axial direction as the first inner ring raceway 16a of the rotating side support member 30a can be made larger than in the first example, thereby achieving weight reduction of the rotational support device 2b for flying object. In addition, since the first inner ring and the nut for pressing an end surface on the inner side in the axial direction of the second inner ring 31b can be omitted, the number of parts can be reduced. Other configurations and effects of the present example are the same as those of the second example.

### Fourth Example

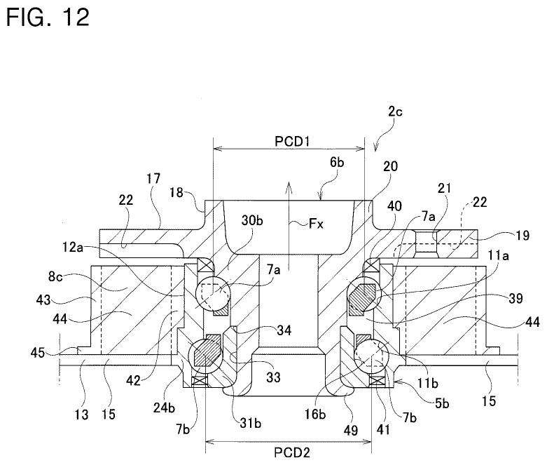

FIG. 12 illustrates a rotational support device for flying object of a fourth example of an embodiment of the present disclosure.

The rotational support device 2c for flying object of the present example is used under the load condition 2, that is, under a condition where only an axial load Fx acts on the rotating body 6b. In the rotational support device 2c for flying object of the present example as well, a very small moment load acts on the rotating body 6b when a flying object moves horizontally or the like during flight. However, the magnitude of the moment load is so small that it can be ignored. For this reason, in the rotational support device 2c for flying object of the present example, the load acting on the rotating body 6b when in use is substantially the axial load Fx only.

As described above, the rotational support device 2c for flying object of the present example is used under a condition where only the axial load Fx acts on the rotating body 6b. For this reason, in the present example, in the method for manufacturing the rotational support device 2c for flying object, a configuration in which the pitch circle diameter PCD1 of the first balls 7a is made smaller than the pitch circle diameter PCD2 of the second balls 7b (PCD1<PCD2) is adopted.

In a case of implementing the structure of the present example, as long as the bearing performance required for the pair of angular ball bearings can be ensured, the difference (PCD2−PCD1) between the pitch circle diameter PCD1 of the first balls 7a and the pitch circle diameter PCD2 of the second balls 7b can be set to any value from the aspect of downsizing the device.

Also in the present example, the stationary body 5b is composed only of the stationary side support member 24b, and the first outer ring raceway 11a and the second outer ring raceway 11b are directly formed on the inner circumferential surface of the stationary side cylindrical portion 26b of the stationary side support member 24b. In addition, the rotating body 6b is formed by combining the rotating side support member 30b and the second inner ring 31b, and the first inner ring raceway 16a is directly formed on the outer circumferential surface of the rotating side support member 30b.

Further, in the present example, the stationary fitting portion 12a of the stationary body 5b has a stepped cylindrical shape in which an outer diameter of a portion in the axial direction on the first side in the axial direction that overlaps with the first outer ring raceway 11a in the radial direction is smaller than an outer diameter of a portion in the axial direction on the second side in the axial direction that overlaps with the second outer ring raceway 11b in the radial direction. By adopting such a configuration, thicknesses in the radial direction of the portions of the stationary body 5b where each of the outer ring raceways 11a, 11b is located are made substantially equal to each other, thereby achieving weight reduction of the stationary body 5b. In the present example, an inner circumferential surface of an annular member 8c fitted to the stationary fitting portion 12a also has a stepped cylindrical shape that matches the stationary fitting portion 12a.

The rotational support device 2c for flying object of the present example is used under a condition where only the axial load Fx acts on the rotating body 6b, and adopts a configuration in which the pitch circle diameter PCD1 of the first balls 7a is smaller than the pitch circle diameter PCD2 of the second balls 7b (PCD1<PCD2). For this reason, while ensuring bearing performance of the pair of angular ball bearings 38a, 38b, specifically rotational efficiency (low heat generation) and L10 life, downsizing of the rotational support device 2c for flying object can be efficiently achieved. Other configurations and effects of the present example are the same as those of the first example.

### Reference Example

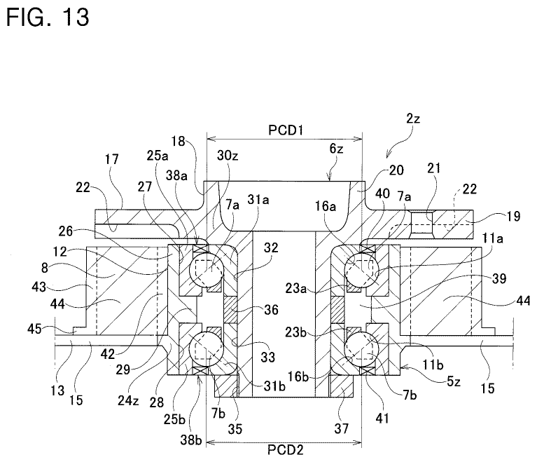

FIG. 13 illustrates a rotational support device for flying object of a reference example of the present disclosure.

The rotational support device 2z for flying object of the present reference example is different from the structure of the first example in that the pitch circle diameter PCD1 of the first balls 7a and the pitch circle diameter PCD2 of the second balls 7b are equal to each other (PCD1=PCD2).

In the present reference example, as a result of adopting a configuration in which PCD1 and PCD2 are equal to each other, an outer diameter of the first outer ring 25a and an outer diameter of the second outer ring 25b are made equal to each other in the stationary body 5z, and an inner diameter of the first inner ring 31a and an inner diameter of the second inner ring 31b are made equal to each other in the rotating body 6z.

For this reason, in the present reference example, an inner diameter of a first outer ring fitting portion 27 to which the first outer ring 25a is internally fitted and an inner diameter of a second outer ring fitting portion 28 to which the second outer ring 25b is internally fitted are made equal to each other in the stationary side support member 24z. Further, in the rotating side support member 30z, an outer diameter of a first inner ring fitting portion 32 to which the first inner ring 31a is externally fitted and an outer diameter of a second inner ring fitting portion 33 to which the second inner ring 31b is externally fitted are made equal to each other. Other configurations and effects of the present reference example are the same as those of the first example.

The rotational support device for flying object of the present disclosure can be implemented by appropriately combining the structures of the embodiments and the structure of the reference example described above within a range that does not cause contradictions.

For example, in a case of implementing the rotational support device for flying object of the present disclosure, in the structures of the first example and the second example, a structure in which the size relationship between the pitch circle diameters PCD1, PCD2 is changed to “PCD1<PCD2” as in the fourth example may be adopted. Even in a case of adopting such a structure, while ensuring bearing performance of the pair of angular ball bearings, specifically rotational efficiency (low heat generation) and L10 life, downsizing of the rotational support device for flying object can be efficiently achieved.

In a case of implementing the rotational support device for flying object of the present disclosure, in the structures of the second example and the third example, a structure in which the size relationship between the pitch circle diameters PCD1, PCD2 is changed to “PCD1=PCD2” as in the reference example may also be adopted.

### EXAMPLES

A simulation performed to confirm effects of the rotational support device for flying object of the present disclosure will be described.

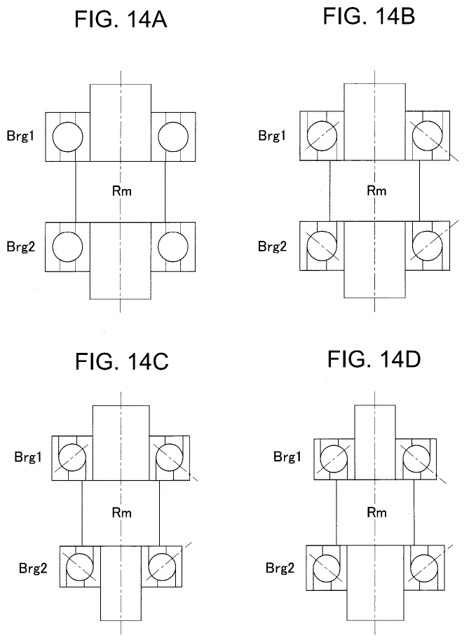

First, a bearing performance simulation was performed for a Comparative Example illustrated in FIG. 14A and a Reference Example 1 illustrated in FIG. 14B, each of which is a model of the rotational support device for flying object.

### Comparative Example

The Comparative Example illustrated in FIG. 14A is a model including a stationary body (not illustrated), a rotating body Rm arranged on the radial inner side of the stationary body so as to be coaxial with each other, and a pair of ball bearings Brg1, Brg2 arranged separated from each other in the axial direction and supporting the rotating body Rm so as to be able to rotate freely with respect to the stationary body, and the PCDs (pitch circle diameters) of the pair of ball bearings Brg1, Brg2 are the same size as each other.

In Comparative Example, each of the ball bearings Brg1, Brg2 is a deep groove ball bearing.

In Comparative Example, the PCD of balls of each of the ball bearings Brg1, Brg2 is 25.5 mm (see Table 1 below).

### Reference Example 1

Reference Example 1 illustrated in FIG. 14B is, similar to Comparative Example, a model including a stationary body (not illustrated), a rotating body Rm arranged on the radial inner side of the stationary body so as to be coaxial with each other, and the pair of ball bearings Brg1, Brg2 that are arranged spaced from each other in the axial direction and support the rotating body Rm so as to be able to rotate freely with respect to the stationary body, and the PCDs of the pair of ball bearings Brg1, Brg2 are equal to each other.

In Reference Example 1, each of the ball bearings Brg1, Brg2 is an angular ball bearing, and a back-to-back type contact angle is applied to the balls of each of the ball bearings Brg1, Brg2. In the angular ball bearings of Reference Example 1, initial contact angle of each of the ball bearings Brg1, Brg2 is 40°.

In Reference Example 1, the PCD of the balls of each of the ball bearings Brg1, Brg2 is approximately the same value (25 mm) as that of Comparative Example (see Table 1 below).

TABLE 1

| | PCD of Balls (mm) |
|---|---|
| <Comparative Example> | 25.5 |
| Deep groove ball bearing | |
| <Reference Example 1> | 25 |
| Angular ball bearing | |

### [Load Conditions in the Bearing Performance Simulation]

In order to confirm the bearing performance under different load conditions regarding the load acting on the rotating body Rm, the following two load conditions A, B were set.
Load condition 1: Axial load Fx+Moment load My
Load condition 2: Axial load Fx only

The axial load Fx acts as an upward lift directed to the first side in the axial direction (the upper side in FIG. 14A to FIG. 14D) generated with the rotation of the propeller. In addition, the moment load My acts when the flying object moves horizontally or the like during flight. In the bearing performance simulation, the axial load Fx was set to 300 N, and the moment load My was set to 50000 N·mm.

### [Preload Conditions in Bearing Performance Simulation]

In order to confirm the bearing performance under different preload conditions, the following three preload conditions were set.
Preload Condition 1: Minimum preload condition, approximately ON for deep groove ball bearings and approximately 350N for angular ball bearings
Preload Condition 2: Low preload condition, approximately 350N for deep groove ball bearings and angular ball bearings respectively
Preload Condition 3: High preload condition, approximately 1000N for deep groove ball bearings and angular ball bearings respectively

In preload condition 1, the reason why the preload of the angular ball bearing was not set to ON is that, unlike deep groove ball bearings, angular ball bearings are normally used with a slight preload applied. Moreover, the slight preload is usually set to be larger than the axial load applied during use. Therefore, in Preload Condition 1, the preload for the angular ball bearings was set to approximately 350N, which is a value slightly larger than the axial load Fx (300N) set in Load Conditions 1 and 2.

As described above, the combinations of the load conditions and the preload conditions set as described above result in six patterns (patterns 1 to 6) as indicated in Table 2 below.

TABLE 2
Rotational Speed of Rotating Body: 5000 rpm/min

| Pattern | Preload Condition | Load Condition |
|---|---|---|
| 1 | Minimum preload | Fx (300N) |
| | (Deep groove: 0N) | My (50000 Nmm) |
| | (Angular: approx. 350N) | |
| 2 | Low preload | Fx (300N) |
| | (approx. 350N) | My (50000 Nmm) |
| 3 | High preload | Fx (300N) |
| | (approx. 1000N) | My (50000 Nmm) |
| 4 | Minimum preload | Fx (300N) |
| | (Deep groove: 0N) | |
| | (Angular: approx. 350N) | |
| 5 | Low preload | Fx (300N) |
| | (approx. 350N) | |
| 6 | High preload | Fx (300N) |
| | (approx. 1000N) | |

In the bearing performance simulation, for each of Comparative Example and Reference Example 1, the rotating body Rm was rotated at 5000 revolutions per minute for each of patterns 1 to 6, and heat generation which is as an index of rotation efficiency and L10 life were obtained. In addition, in patterns 1 to 3 where moment load My acts on the rotating body Rm, moment rigidity (tilt rigidity) was also obtained.

The heat generation is represented by the total heat generation of each of the ball bearings Brg1, Brg2. The smaller the heat generation value, the higher the rotation efficiency.

The moment rigidity is represented by an inclination angle of the central axis of the rotating body Rm with respect to the central axis of the stationary body when the moment load My is applied to the rotating body Rm. The smaller the value of the inclination angle, the higher the moment rigidity.

### [Bearing Performance Simulation in Pattern 1]

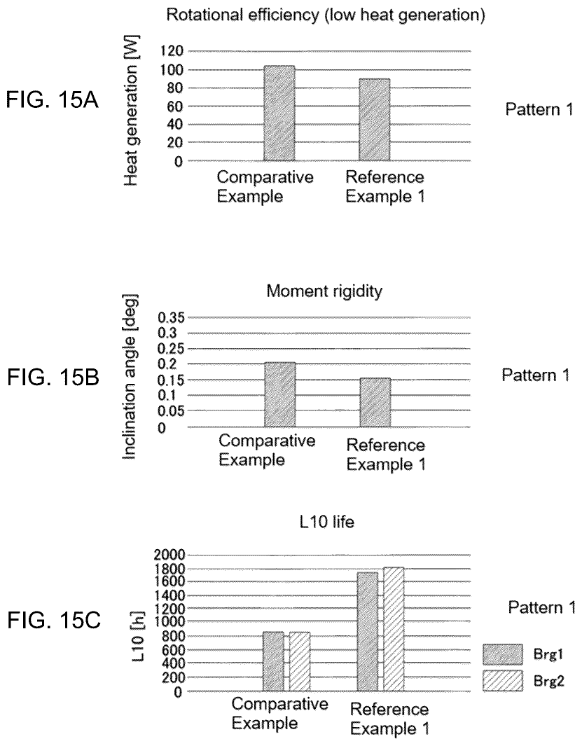

Results of the bearing performance simulation in pattern 1 are illustrated in FIG. 15A to FIG. 15C. As indicated in these results, in pattern 1, it was confirmed that Reference Example 1 was superior to Comparative Example in all bearing performances (rotational efficiency (low heat generation), moment rigidity, and L10 life) obtained from the bearing performance simulation.

That is, in pattern 1, it was confirmed that all bearing performances obtained from the bearing performance simulation were improved only by changing the type of the pair of ball bearings Brg1, Brg2 from a pair of deep groove ball bearings to a pair of angular ball bearings with a back-to-back contact angle, without substantially changing the sizes of the pair of ball bearings Brg1, Brg2. Moreover, in Reference Example 1, it was confirmed that all of the above described bearing performances were improved even though the PCD of the balls was slightly smaller (by 0.5 mm) than that in Comparative Example.

Then, based on the results of the bearing performance simulation in pattern 1 described above, a simulation under the conditions of pattern 1 (hereinafter referred to as “additional simulation in pattern 1”) was performed to confirm to what extent the sizes of the pair of ball bearings Brg1, Brg2 could be reduced in the structure of Reference Example 1, within a range in which the bearing performance would not become lower than that of Comparative Example.

In the additional simulation in pattern 1, first, under the condition where the PCDs of the pair of ball bearings Brg1, Brg2 were made equal to each other in the structure of Reference Example 1, the PCD was gradually reduced in steps. As a result, when the PCD was reduced to a certain extent, the moment rigidity became approximately the same as that of Comparative Example. The model at that stage is defined as Reference Example 2. The PCD of the balls of Reference Example 2 is indicated together with the PCD of the balls of Comparative Example in Table 3 below.

TABLE 3

| | PCD of Balls (mm) |
|---|---|
| <Comparative Example> | 25.5 |
| Deep groove ball bearing | |
| <Reference Example 2> | 23.5 |
| Angular ball bearing | |

The rotational efficiency (low heat generation) and the L10 life of Reference Example 2 were still superior to those of Comparative Example.

In the additional simulation in pattern 1, next, with respect to the structure of Reference Example 1, as illustrated in FIG. 14C or FIG. 14D, under a condition in which the PCDs of the balls of the ball bearing Brg1 on the first side in the axial direction and the ball bearing Brg2 on the second side in the axial direction are made different from each other, the PCDs of the balls of the respective ball bearings Brg1, Brg2 were gradually reduced in steps.

As a result, it was found that the PCD of the balls of the ball bearing Brg1 has a significant influence on the moment rigidity, and from the aspect of ensuring the moment rigidity, the PCD of the balls of the ball bearing Brg1 cannot be reduced too much. That is, in the pattern 1, from the aspect of efficiently achieving downsizing while ensuring bearing performance, it was found to be effective to adopt a structure in which the PCD of the balls of the ball bearing Brg2 is made smaller than the PCD of the balls of the ball bearing Brg1, as illustrated in FIG. 14C.

With respect to the structure of Reference Example 1, under the condition where the PCD of the balls of the ball bearing Brg2 is smaller than the PCD of the balls of the ball bearing Brg1 as illustrated in FIG. 14C, the PCDs of the balls of the ball bearings Brg1, Brg2 were gradually reduced in steps. As a result, when the PCDs were reduced to a certain extent, the moment rigidity became approximately the same as that of Comparative Example. The model at that stage is defined as Example 1. The PCDs of the balls of Example 1, together with the PCDs of the balls of Comparative Example, are indicated in Table 4 below.

TABLE 4

| | PCD of Balls (mm) |
|---|---|
| <Comparative Example> | 25.5 |
| Deep groove ball bearing | |

| | | |
|---|---|---|
| <Example 1> | Brg1 | 24 |
| Angular ball bearing | Brg2 | 22 |

The rotational efficiency (low heat generation) and the L10 life of Example 1 were still superior to those of Comparative Example.

As is apparent from Table 3 and Table 4, Reference Example 2 and Example 1 are structures capable of ensuring bearing performance equal to or higher than that of Comparative Example, while allowing the PCDs of the balls of the ball bearings Brg1, Brg2 to be reduced compared to Comparative Example. In particular, in Example 1, the PCD of the balls of the ball bearing Brg2 can be reduced more efficiently than in Reference Example 2, and the overall size of the rotational support device for flying object can be reduced more efficiently.

### [Bearing Performance Simulation in Pattern 2]

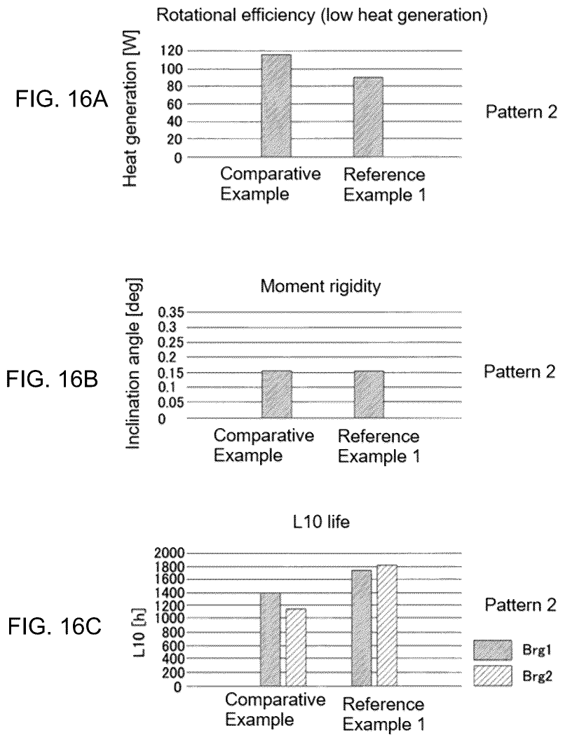

Results of the bearing performance simulation in pattern 2 are indicated in FIG. 16A to FIG. 16C. As indicated by these results, in pattern 2, of the bearing performance obtained in the bearing performance simulation, the rotational efficiency (low heat generation) and L10 life of Reference Example 1 were superior to those of Comparative Example, and the moment rigidity of Reference Example 1 was confirmed to be equivalent to that of Comparative Example.

That is, in pattern 2, it was confirmed that, of the bearing performance obtained in the bearing performance simulation, the rotational efficiency (low heat generation) and L10 life were improved only by changing the type of the pair of ball bearings Brg1, Brg2 from a pair of deep groove ball bearings to a pair of angular ball bearings with a back-to-back contact angle, without substantially changing the sizes of the pair of ball bearings Brg1, Brg2.

Then, based on the results of the bearing performance simulation in pattern 2 described above, a simulation under the conditions of pattern 2 (hereinafter referred to as “additional simulation in pattern 2”) was performed to confirm to what extent the sizes of the pair of ball bearings Brg1, Brg2 can be reduced in the structure of Reference Example 1, within a range in which the bearing performance would not become lower than that of Comparative Example.

However, the size of the ball bearing Brg1 has a significant influence on the moment rigidity. Therefore, under the conditions of pattern 2, if a modification is made to reduce the size of the ball bearing Brg1 in the structure of Reference Example 1, the moment rigidity immediately becomes lower than that of Comparative Example.

In the additional simulation in pattern 2, as illustrated in FIG. 14C, only a simulation was performed under the condition where the PCD of the balls of the ball bearing Brg2 is made smaller than the PCD of the balls of the ball bearing Brg1, and the PCD of the balls of the ball bearing Brg2 alone was gradually reduced in steps. As a result, similar to the case of the additional simulation in pattern 1, it was confirmed that the PCD could be reduced to a certain extent within a range in which the bearing performance would not become lower than that of Comparative Example. The model thus confirmed is defined as Example 2. It was found that Example 2 can also efficiently reduce the overall size of the rotational support device for flying object.

### [Bearing Performance Simulation in Pattern 3]

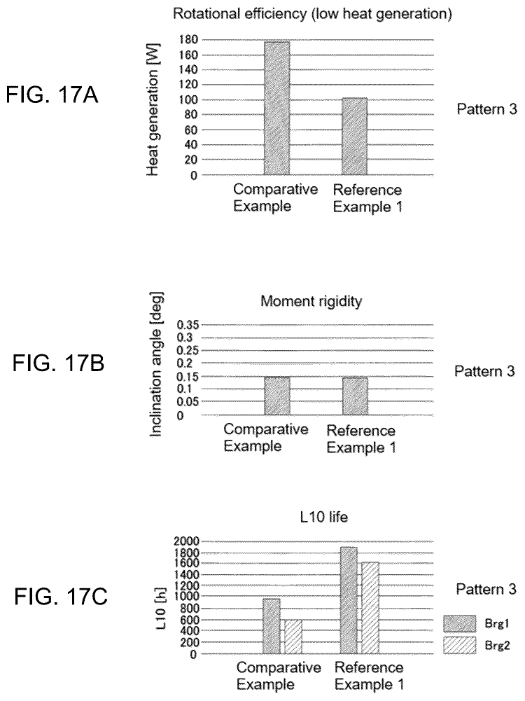

Results of the bearing performance simulation in pattern 3 are indicated in FIG. 17A to FIG. 17C. As indicated by these results, in pattern 3 as well, similar to the case of pattern 2, of all the bearing performance obtained in the bearing performance simulation, the rotational efficiency (low heat generation) and L10 life of Reference Example 1 were superior to those of Comparative Example, and the moment rigidity of Reference Example 1 was confirmed to be equivalent to that of Comparative Example.

That is, in the pattern 3 as well, it was confirmed that, of the bearing performance obtained in the bearing performance simulation, the rotational efficiency (low heat generation) and L10 life were improved only by changing the type of the pair of ball bearings Brg1, Brg2 from a pair of deep groove ball bearings to a pair of angular ball bearings with a back-to-back contact angle, without substantially changing the sizes of the pair of ball bearings Brg1, Brg2.

Then, based on the results of the bearing performance simulation in pattern 3 described above, an additional simulation similar to the additional simulation in pattern 2 was performed in pattern 3 as well. Specifically, in pattern 3, as illustrated in FIG. 14C, a simulation (hereinafter referred to as “additional simulation in pattern 3”) was performed under the condition where the PCD of the balls of the ball bearing Brg2 is made smaller than the PCD of the balls of the ball bearing Brg1, and the PCD of the balls of the ball bearing Brg2 alone was gradually reduced in steps.

As a result, similar to the case of the additional simulation in pattern 1 and the additional simulation in pattern 2, it was confirmed that the PCD of the balls of the Brg2 could be reduced to a certain extent within a range in which the bearing performance would not become lower than that of Comparative Example. The model thus confirmed is defined as Example 3. It was found that Example 3 can also efficiently reduce the overall size of the rotational support device for flying object.

### [Bearing Performance Simulation in Pattern 4]

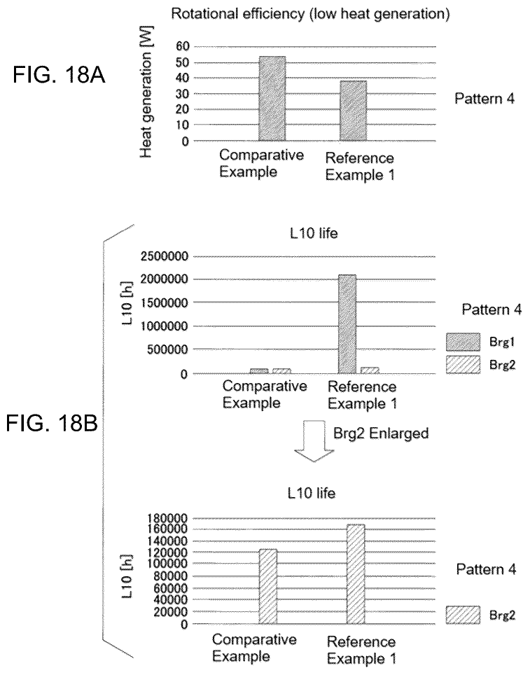

Results of the bearing performance simulation in pattern 4 are indicated in FIG. 18A and FIG. 18B. As indicated by these results, in pattern 4, all the bearing performance (rotational efficiency (low heat generation), L10 life) of Reference Example 1 obtained in the bearing performance simulation were superior to those of Comparative Example.

That is, in the pattern 4 as well, it was confirmed that, all the bearing performance obtained in the bearing performance simulation were improved only by changing the type of the pair of ball bearings Brg1, Brg2 from a pair of deep groove ball bearings to a pair of angular ball bearings with a back-to-back contact angle, without substantially changing the sizes of the pair of ball bearings Brg1, Brg2.

In the pattern 4, the load acting on the rotating body Rm is only the axial load Fx directed to the first side in the axial direction. For this reason, in Reference Example 1, a supporting share of the load acting on the rotating body Rm is significantly larger in the ball bearing Brg2 than in the ball bearing Brg1. Therefore, in Reference Example 1, surface pressure acting on a rolling contact portion between balls and raceways is significantly smaller in the ball bearing Brg1 than in the ball bearing Brg2. Due to such circumstances, in Reference Example 1, the L10 life is significantly longer in the ball bearing Brg1 than in the ball bearing Brg2.

Then, based on the results of the bearing performance simulation in pattern 4 described above, a simulation (hereinafter referred to as “additional simulation in pattern 4”) was performed under the condition of pattern 4 for the structure of Reference Example 1 to confirm to what extent the sizes of the pair of ball bearings Brg1, Brg2 can be reduced within a range in which the bearing performance would not become lower than that of Comparative Example.

In the additional simulation in pattern 4, first, under the condition where the PCDs of the pair of ball bearings Brg1, Brg2 were made equal to each other in the structure of Reference Example 1, the PCD was gradually reduced in steps as illustrated in FIG. 14B. As a result, when the PCD was reduced to a certain extent, the L10 life of the ball bearing Brg2 became approximately the same as that of Comparative Example. The model at that stage is defined as Reference Example 3. The PCD of the balls of Reference Example 3 is indicated together with the PCD of the balls of Comparative Example in Table 5 below.

TABLE 5

| | PCD of Balls (mm) |
|---|---|
| <Comparative Example> | 25.5 |
| Deep groove ball bearing | |
| <Reference Example 3> | 22 |
| Angular ball bearing | |

The rotational efficiency (low heat generation) and the L10 life of Reference Example 3 were still superior to those of Comparative Example.

In the additional simulation in pattern 4, next, with respect to the structure of Reference Example 1, as illustrated in FIG. 14D, under a condition in which the PCD of the balls of the ball bearing Brg1 is made smaller than the PCD of the balls of the ball bearing Brg2, the PCDs of the balls of the respective ball bearings Brg1, Brg2 were gradually reduced in steps.

The reason why such an additional simulation was performed under the condition where the PCD of the balls of the ball bearing Brg1 is made smaller than the PCD of the balls of the ball bearing Brg2 is that, in the pattern 4, the supporting share of the load acting on the rotating body Rm is significantly smaller in the ball bearing Brg1 than in the ball bearing Brg2. Further, in the pattern 4, since no moment load My acts on the rotating body Rm, it is not necessary to ensure a large PCD of the balls of the ball bearing Brg1, which has a significant influence on the moment rigidity. That is, adopting a condition in which the PCD of the balls of the ball bearing Brg1 is made smaller than the PCD of the balls of the ball bearing Brg2 makes it possible to efficiently reduce the PCDs of the balls of the ball bearings Brg1, Brg2 respectively while ensuring the L10 life of each of the ball bearings Brg1, Brg2.

With respect to the structure of Reference Example 1, under the condition where the PCD of the balls of the ball bearing Brg1 is smaller than the PCD of the balls of the ball bearing Brg2 as illustrated in FIG. 14D, the PCDs of the balls of the ball bearings Brg1, Brg2 were gradually reduced in steps. As a result, when the PCDs were reduced to a certain extent, the L10 life of the ball bearing Brg2 became approximately the same as that of Comparative Example. The model at that stage is defined as Example 4. The PCDs of the balls of Example 4, together with the PCDs of the balls of Comparative Example, are indicated in Table 6 below.

TABLE 6

| | PCD of Balls (mm) |
|---|---|
| <Comparative Example> | 25.5 |
| Deep groove ball bearing | |

| | | |
|---|---|---|
| <Reference Example 4> | Brg1 | 18 |
| Angular ball bearing | Brg2 | 22 |

The rotational efficiency (low heat generation) and the L10 life of the ball bearing Brg1 were still superior to those of Comparative Example.

As is apparent from Table 5 and Table 6, Reference Example 3 and Example 4 are structures capable of ensuring bearing performance equal to or higher than that of Comparative Example, while allowing the PCDs of the balls of the ball bearings Brg1, Brg2 to be reduced compared to Comparative Example. In particular, in Example 4, the PCD of the balls of the ball bearing Brg1 can be reduced more efficiently than in Reference Example 3, and the overall size of the rotational support device for flying object can be reduced more efficiently.

### [Bearing Performance Simulation in Pattern 5]

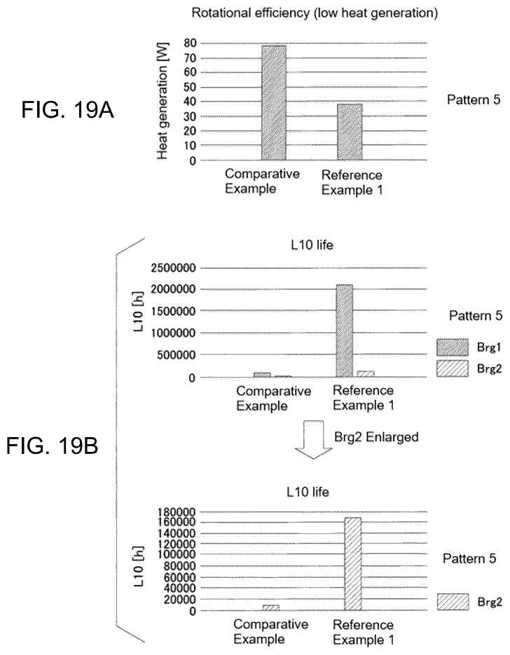

Results of the bearing performance simulation in pattern 5 are indicated in FIG. 19A and FIG. 19B. As indicated by these results, in pattern 5 as well, all the bearing performance (rotational efficiency (low heat generation), L10 life) of Reference Example 1 obtained in the bearing performance simulation were superior to those of Comparative Example.

That is, in the pattern 5 as well, it was confirmed that, all the bearing performance obtained in the bearing performance simulation were improved only by changing the type of the pair of ball bearings Brg1, Brg2 from a pair of deep groove ball bearings to a pair of angular ball bearings with a back-to-back contact angle, without substantially changing the sizes of the pair of ball bearings Brg1, Brg2.

Then, based on the results of the bearing performance simulation in pattern 5 described above, an additional simulation similar to the additional simulation in pattern 4 was performed in pattern 5 as well.

As a result, similar to the case of the additional simulation in pattern 4, it was confirmed that the PCD of the balls of each of the ball bearings Brg1, Brg2 could be reduced to a certain extent within a range in which the bearing performance would not become lower than that of Comparative Example. The model thus confirmed is defined as Example 5. It was found that Example 5 can also efficiently reduce the overall size of the rotational support device for flying object.

### [Bearing Performance Simulation in Pattern 6]

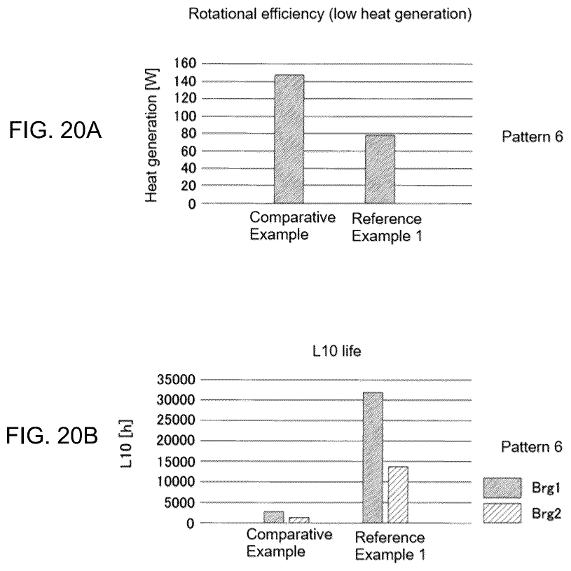

Results of the bearing performance simulation in pattern 6 are indicated in FIG. 20A and FIG. 20B. As indicated by these results, in pattern 6 as well, all the bearing performance (rotational efficiency (low heat generation), L10 life) of Reference Example 1 obtained in the bearing performance simulation were superior to those of Comparative Example.

That is, in the pattern 6 as well, it was confirmed that, all the bearing performance obtained in the bearing performance simulation were improved only by changing the type of the pair of ball bearings Brg1, Brg2 from a pair of deep groove ball bearings to a pair of angular ball bearings with a back-to-back contact angle, without substantially changing the sizes of the pair of ball bearings Brg1, Brg2.

Then, based on the results of the bearing performance simulation in pattern 6 described above, an additional simulation similar to the additional simulation in pattern 4 was performed in pattern 6 as well.

As a result, similar to the case of the additional simulation in pattern 4, it was confirmed that the PCD of the balls of each of the ball bearings Brg1, Brg2 could be reduced to a certain extent within a range in which the bearing performance would not become lower than that of Comparative Example. The model thus confirmed is defined as Example 6. It was found that Example 6 can also efficiently reduce the overall size of the rotational support device for flying object.

### [Summary of Simulations]

From the simulation results of the patterns 1 to 3 described above, it was found that, in the rotational support device for flying object used under the load condition 1 (axial load Fx+moment load My), regardless of applied preload conditions, as illustrated in FIG. 14C, the overall size of the rotational support device for flying object can be effectively reduced by adopting a structure in which the PCD of the balls of the ball bearing Brg2 is made smaller than the PCD of the balls of the ball bearing Brg1.

From the simulation results of the patterns 4 to 6 described above, it was found that, in the rotational support device for flying object used under the load condition 2 (only axial load Fx), regardless of applied preload conditions, as illustrated in FIG. 14D, the overall size of the rotational support device for flying object can be effectively reduced by adopting a structure in which the PCD of the balls of the ball bearing Brg1 is made smaller than the PCD of the balls of the ball bearing Brg2.

### [Further Simulations]

In the simulations described above, in Reference Examples 1 to 3 and Examples 1 to 6, an initial contact angle of the pair of angular ball bearings was set to 40°. However, when similar simulations (further simulations) were performed in which the initial contact angle of the pair of angular ball bearings was changed to 15°, 25°, and 30°, respectively, results similar to the case where the initial contact angle of the pair of angular ball bearings was set to 40° were obtained regarding the bearing performance. Further, it was also confirmed that, in both the load conditions 1 and 2, as the initial contact angle of the pair of angular ball bearings increased in order of 15°, 25°, 30°, and 40°, the rotational efficiency (low heat generation property) and L10 life were improved.

### [Method for Manufacturing the Rotational Support Device for Flying Object]

As described above, since similar simulation results regarding the bearing performance were obtained regardless of the magnitude of the initial contact angle of the pair of angular ball bearings, in a case of implementing a method for manufacturing the rotational support device for flying object of the present disclosure, it is only necessary to determine the size relationship between the pitch circle diameter PCD1 of the first balls and the pitch circle diameter PCD2 of the second balls in accordance with the load conditions acting on the rotating body.

Specifically, regarding the rotational support device for flying object to be manufactured, in a case where a load acting on the rotating body is the axial load Fx+moment load My, as in the first to third examples of the embodiment, it is only necessary to adopt a structure in which the pitch circle diameter PCD2 of the second balls is made smaller than the pitch circle diameter PCD1 of the first balls. In contrast, regarding the rotational support device for flying object to be manufactured, in a case where a load acting on the rotating body is only the axial load Fx, as in the fourth example of the embodiment, it is only necessary to adopt a structure in which the pitch circle diameter PCD1 of the first balls is made smaller than the pitch circle diameter PCD2 of the second balls. By doing so, it is possible to efficiently achieve downsizing of the rotational support device for flying object while ensuring the bearing performance of the pair of angular ball bearings.

### REFERENCE SIGNS LIST

1 Rotational drive device for flying object
2, 2a, 2b, 2c, 2z Rotational support device for flying object
3 Drive motor
4 Propeller
5, 5a, 5b, 5z Stationary body
6, 6a, 6b, 6z Rotating body
7a First balls
7b Second balls
8, 8a, 8b, 8c Annular member
9 Motor stator
10 Motor rotor
11a First outer ring raceway
11b Second outer ring raceway
12, 12a Stationary fitting portion
13 Stationary flange
14 Support holes
15 Window holes
16a First inner ring raceway
16b Second inner ring raceway
17 Rotor abutment portion
18 Rotor fitting portion
19 Rotating flange
20 Pilot portion
21 Mounting holes
22 Flange recess portions
23a, 23b Cages
24, 24a, 24z Stationary side support member
25a First outer ring
25b Second outer ring
26, 26a, 26b Stationary side cylindrical portion
27 First outer ring fitting portion
28 Second outer ring fitting portion
29 Protrusion
30, 30a, 30b, 30z Rotating side support member
31a First inner ring
31b Second inner ring
32 First inner ring fitting portion
33 Second inner ring fitting portion
34 Stepped surface
35 Male screw portion
36 Spacer
37 Nut
38a First angular ball bearings
38b Second angular ball bearings
39 Rolling element installation space
40 First-side seal device
41 Second-side seal device
42 Inner diameter side cylindrical portion
43 Outer diameter side cylindrical portion
44 Connecting portion
45 Outward flange portion
46 Side plate portion
47 Tubular portion
48 Ventilation holes
49 Crimped portion

1. A rotational support device for flying object, comprising:
a stationary body having double-row outer ring raceways, each of which is of an angular type, on an inner circumferential surface thereof,
a rotating body having double-row inner ring raceways, each of which is of an angular type, on an outer circumferential surface thereof, and capable of supporting a propeller of a flying object on a first side in an axial direction,
balls arranged between the double-row outer ring raceways and the double-row inner ring raceways in a state where a back-to-back contact angle is applied to each row of balls, and
a pitch circle diameter of first balls of the balls arranged on a first side in the axial direction and a pitch circle diameter of second balls of the balls arranged on a second side in the axial direction are different from each other.

2. The rotational support device for flying object according to claim 1, wherein
the stationary body has a stationary side support member, a first outer ring having a first outer ring raceway arranged on the first side in the axial direction on an inner circumferential surface thereof and internally fitted to the stationary side support member, and a second outer ring having a second outer ring raceway arranged on the second side in the axial direction on an inner circumferential surface thereof and internally fitted to the stationary side support member, and
the rotating body has a rotating side support member, a first inner ring having a first inner ring raceway arranged on the first side in the axial direction on an outer circumferential surface thereof and externally fitted to the rotating side support member, and a second inner ring having a second inner ring raceway arranged on the second side in the axial direction on an outer circumferential surface thereof and externally fitted to the rotating side support member.

3. The rotational support device for flying object according to claim 2, wherein the first outer ring and the second outer ring are arranged separated from each other in the axial direction, and the first inner ring and the second inner ring are arranged separated from each other in the axial direction.

4. The rotational support device for flying object according to claim 1, wherein the stationary body includes a stationary side support member in which a first outer ring raceway arranged on the first side in the axial direction on an inner circumferential surface thereof and a second outer ring raceway arranged on the second side in the axial direction are directly formed on the inner circumferential surface thereof.

5. The rotational support device for flying object according to claim 4, wherein the rotating body includes a rotating side support member in which a first inner ring raceway arranged on the first side in the axial direction is directly formed on the outer circumferential surface thereof, and an inner ring having a second inner ring raceway arranged on the second side in the axial direction on an outer circumferential surface thereof and externally fitted to the rotating side support member.

6. A method for manufacturing a rotational support device for flying object, the rotational support device for flying object comprising:
a stationary body having double-row outer ring raceways, each of which is of an angular type, on an inner circumferential surface thereof,
a rotating body having double-row inner ring raceways, each of which is of an angular type, on an outer circumferential surface thereof, and is capable of supporting a propeller of a flying object on a first side in an axial direction, and
balls arranged between the double-row outer ring raceways and the double-row inner ring raceways in a state where a back-to-back contact angle is applied to each row of balls, wherein
a pitch circle diameter of first balls of the balls arranged on the first side in the axial direction and a pitch circle diameter of second balls of the balls arranged on a second side in the axial direction are different from each other,
the method includes a step of determining a size relationship between the pitch circle diameter of the first balls and the pitch circle diameter of the second balls in accordance with load conditions acting on the rotating body during use of a flying object to which the rotational support device for flying object is applied.
